(19) United States
(12) Patent Application Publication
(10) Pub. No.: US 2012/0211629 A1
(43) Pub. Date: Aug. 23, 2012

(54) Holder for Beverage Containers

(76) Inventor: Thomas J. Shaw, Frisco, TX (US)

(21) Appl. No.: 13/032,962

(22) Filed: Feb. 23, 2011

(51) Int. Cl. A47G 29/00; G09F 3/00

(52) U.S. Cl. 248/346.03; 40/324

(57) ABSTRACT

A beverage container holder comprising a base and at least one structure projecting upwardly from the base, wherein the at least one structure projecting upwardly from the base releasably holds a beverage container inserted into engagement with the at least one structure, wherein the base comprises portions projecting horizontally beyond the at least one upwardly projecting structure when the beverage holder is disposed in a resting position on an underlying support surface to provide additional tip-over resistance to the beverage container, and wherein either the base or the at least one structure projecting upwardly includes a visible element that is singularly identifiable by the user.

### BACKGROUND OF THE INVENTION

1. Field of the Invention

This invention relates to holders for beverage containers such as bottles, cans and glasses. Beverage container holders made in accordance with the invention are desirably releasably attachable to or engageable with beverage containers; preferably embody a low profile relative to the width, diameter or other principal transverse (“substantially horizontal”) dimension of the base, are resistant to accidental turnover and associated spillage, and comprise one or more indicia that assist a user in differentiating his or her beverage from that of another.

2. Description of Related Art

Conventional holders for beverage containers include, for example, insulated polymeric beverage container holders (sometimes referred to as “koozies” or “coosies”), handle attachments for cans or bottles, vehicular beverage holders, and the like. U.S. Pat. No. 6,578,809 discloses flexible bases that grip beverage holders such as glasses, cans or bottles and are also designed to absorb condensation or minor spillage. U.S. Pat. Nos. 7,207,538 and 7,726,499 disclose plastic bottle holders having a handle. U.S. Pat. Nos. 5,282,598 and 7,748,678 disclose beverage container holders that can be mounted in or on a vehicle. U.S. Pat. No. 6,141,969 discloses a beverage vessel holder in which a thermoelectric device provides heating and/or cooling to a beverage vessel in use. U.S. Pat. No. 4,889,302 discloses a beverage container holder useful for supporting a drinking container on a wide variety of surfaces and for keeping the beverage hot or cold. U.S. Pat. No. 6,877,705 discloses a coaster attachable to the base of stemware to be carried with the stemware, the coaster comprising a material that will absorb and prevent the transmission of moisture to an underlying substrate. U.S. Pat. No. 7,328,876 discloses a cup holder stretchable around a beverage holder that is also insertable into a beverage holder in a vehicle console. Also previously known are identification “bracelets” attachable to stemware to assist users in identifying the beverage of a particular user.

### SUMMARY OF THE INVENTION

Notwithstanding the various types and kinds of beverage container holders previously disclosed, there remains a need for a beverage container holder that is easily attachable to and detachable from a beverage container such as a can or bottle, that remains attached to the beverage container during consumption of the contained beverage, that comprises at least one design element by which the beverage holder is readily and singularly identifiable by the user as being his or her own, and that preferably comprises at least one element providing resistance to accidental tip-over and resultant spillage during use.

Beverage container holders are disclosed herein that embody all the benefits and advantages identified above, and that are lightweight, inexpensive, injection moldable, and are easily attachable to and detachable from beverage containers of different types and sizes.

According to one embodiment of the invention, a beverage container holder is disclosed that comprises a base and an upwardly projecting substantially cylindrical, flexing sidewall, the base further comprising a transverse dimension that is greater than the height of the sidewall, wherein the sidewall is configured to grip a beverage container inserted into a recess defined by the sidewall so that the beverage container abuts against a portion of the base, and wherein either the base or sidewall includes a visible element that is singularly identifiable by the user. Optionally, the sidewall can contain a plurality of arcuately spaced projections directed inwardly from the sidewall to grip the beverage container.

According to another embodiment of the invention, a beverage container holder is disclosed that comprises a base and an upwardly projecting substantially cylindrical, flexing sidewall, wherein the sidewall is configured to grip a beverage container inserted into a recess defined by the sidewall, wherein the base further comprises a transverse dimension that is greater than the diameter of a beverage container plus twice the thickness of the sidewall, and wherein either the base or sidewall includes a visible element that is singularly identifiable by the user.

According to another embodiment of the invention, a beverage container holder is disclosed that comprises a base and a plurality of upwardly projecting, circumferentially spaced-apart, flexing, arcuate wall sections, each arcuate wall section cooperating with the others to grip a beverage container inserted between or among them, and wherein either the base or at least one wall section includes a visible element that is singularly identifiable by the user.

According to another embodiment of the invention, a beverage container holder is disclosed that comprises a base and a plurality of upwardly projecting, circumferentially spaced-apart, flexing, arcuate wall sections, each arcuate wall section cooperating with the others to grip a beverage container inserted between or among them, wherein the base further comprises a transverse dimension that is greater than the diameter of the beverage container plus twice the thickness of an arcuate wall section, and wherein either the base or at least one wall section includes a visible element that is singularly identifiable by the user.

According to another embodiment of the invention, a beverage container holder is disclosed that comprises a base and at least one structure projecting upwardly from the base, wherein the at least one structure projecting upwardly from the base releasably holds a beverage container inserted into engagement with the at least one structure, wherein the base comprises portions projecting horizontally beyond the at least one upwardly projecting structure when the beverage holder is disposed in a resting position on an underlying support surface to provide additional tip-over resistance to the beverage container, and wherein either the base or the at least one structure projecting upwardly includes a visible element that is singularly identifiable by the user.

According to another embodiment of the invention, a beverage container holder is disclosed wherein each beverage container holder is made in accordance with any of paragraphs [0005-0009] above and wherein each such beverage holder has at least one aperture extending through the base.

According to another embodiment of the invention, a beverage container holder is disclosed that comprises a material or an insert in combination with a configuration specifically intended to increase the mass of the beverage container holder, especially at or near its lower end, and thereby lower the center of gravity of the beverage container holder and any beverage container releasably engaged by the holder.

According to another embodiment of the invention, a plurality of beverage container holders are disclosed wherein each beverage container holder is made in accordance with any or a combination of paragraphs [0005-0010] above and wherein each such beverage container holder has a visible element that makes it singularly identifiable relative to the others.

### BRIEF DESCRIPTION OF THE DRAWINGS

The apparatus of the invention is further described and explained in relation to the following drawings wherein:

FIG. 1 is a front elevation view, partially broken away and partially in section, of a beverage container holder;

FIG. 2 is a top plan view of the beverage container holder of FIG. 1;

FIG. 3 is a cross-sectional front elevation view taken along line 3-3 of FIG. 2;

FIG. 4 is a beverage container holder similar to that of FIG. 3 as applied to a beverage container that is a can;

FIG. 5 is a beverage container holder similar to that of FIG. 3 but having a taller sidewall and applied to a beverage container that is a bottle;

FIG. 6 is a top plan view of a beverage container holder similar to that of FIG. 2 but having a base portion with a differently configured perimeter;

FIG. 7 is a top plan view of a beverage container holder similar to that of FIG. 2 but having a base portion with a differently configured perimeter;

FIG. 8 is a top plan view of a beverage container holder similar to that of FIG. 2 but having a base portion with a differently configured perimeter;

FIG. 9 is a top perspective view of another beverage container holder;

FIG. 10 is a top plan view of the beverage container holder of FIG. 9;

FIG. 11 is a front elevation view of the beverage container holder of FIG. 9;

FIG. 12 is a bottom plan view of the beverage container holder of FIG. 12;

FIG. 13 is a top perspective view of another beverage container holder;

FIG. 14 is a top plan view of the beverage container holder of FIG. 13;

FIG. 15 is a front elevation view of the beverage container holder of FIG. 13;

FIG. 16 is a bottom plan view of the beverage container holder of FIG. 13;

FIG. 17 is a top perspective view of another beverage container holder;

FIG. 18 is a top plan view of the beverage container holder of FIG. 17;

FIG. 19 is a front elevation view of the beverage container holder of FIG. 17;

FIG. 20 is a bottom plan view of the beverage container holder of FIG. 17;

FIG. 21 is a top perspective view of another beverage container holder;

FIG. 22 is a top plan view of the beverage container holder of FIG. 21;

FIG. 23 is a front elevation view of the beverage container holder of FIG. 21; and

FIG. 24 is a bottom plan view of the beverage container holder of FIG. 21.

### DESCRIPTION OF THE PREFERRED EMBODIMENTS

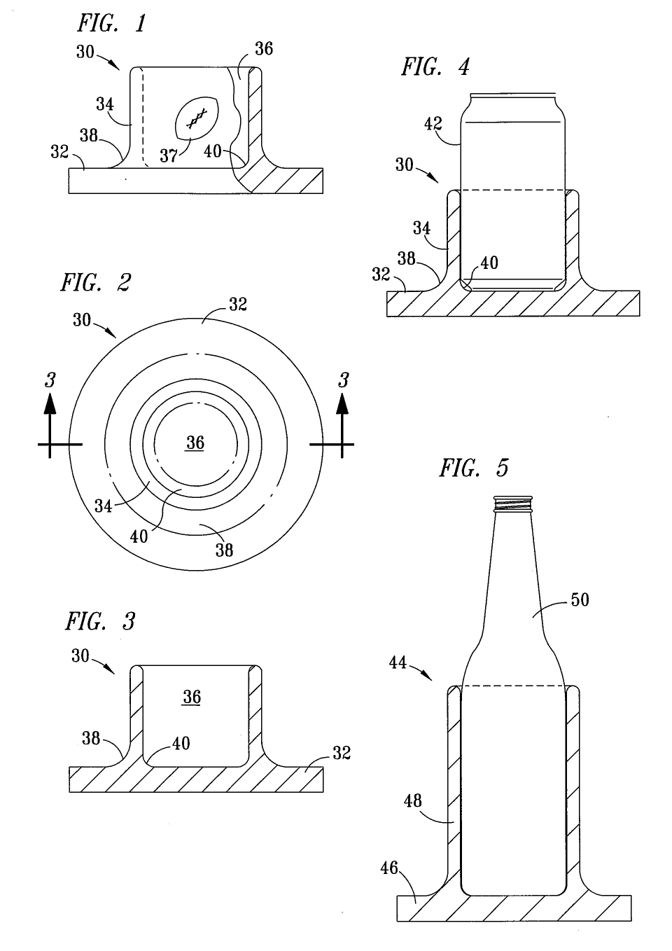

Referring to FIGS. 1-4, a beverage container holder 30 is disclosed that comprises base 32, sidewall 34 having an inside surface defining a continuous, substantially cylindrical interior void 36, and indicia 37 visible on the outside surface of sidewall 34. Beverage container holder 30 is preferably unitarily molded or otherwise formed from a moldable, commercially available polymeric resin or from any other material suitable for such purposes as determined by those of ordinary skill in the art. Sidewall 30 is desirably sufficiently flexible to facilitate insertion and removal of beverage containers during use, and is desirably resistant to breakage upon such impacts as might reasonably be encountered during use a holder for beverage containers such as, for example, can 42 shown in FIG. 4. Outside radius 38 and inside radius 40 are desirably provided along the circumferentially extending intersection between base 32 and sidewall 34 to relieve stress concentrations that might otherwise occur in those sections of beverage holder container 30, and thereby reduce the likelihood of breakage during manufacture, storage, transport or use. It will also be appreciated that the inside surface of sidewall 34 will likely have a slight inward taper from top to bottom to facilitate molding. Indicia 37 can be any shape, image, graphic or text capable of singularly identifying that particular beverage container holder to one or more users in a situation or setting where several beverage container holders of the same general type are present. Such indicia 37 can, for example, take the form of an adhesively applied decal, a painted design, a molded or embossed character or image. In FIG. 1, for illustrative purposes only, indicia 37 is the image of a football.

According to one preferred embodiment of the invention, in order to provide some resistance to accidental tip-over during use, base 32 has a thickness about the same or slightly greater than the thickness of sidewall 34, and is depicted as having a circular perimeter with a diameter that is greater than the height of sidewall 34 above base 32. It will be appreciated by those of ordinary skill in the art upon reading this disclosure, however, that for some uses, such as holding beverage bottles, a beverage container holder having a base that is wider than the height of the sidewall is not practical. This is illustrated, for example, with reference to FIG. 5, where beverage container holder 44 is made similarly to beverage container holder 30 of FIGS. 1-4 except that the height of sidewall 48 above base 46 is greater than the width or diameter of base 46 to provide additional support to bottle 50. It should be appreciated upon reading this disclosure, however, that bottle 50 can also be used with a beverage container holder configured similarly to that shown in FIGS. 1-4, or in accordance with one or more other embodiments of the invention. For example, and referring this time to FIGS. 1-5, according to another embodiment of the invention, base 32, 46 has a principal transverse dimension (the diameter) that is greater than the outside diameter of sidewall 34, 48 respectively. Said differently, base 32, 46 has a principal transverse dimension that is greater than the diameter of the beverage container to be held plus twice the thickness of sidewall 34, 48 respectively.

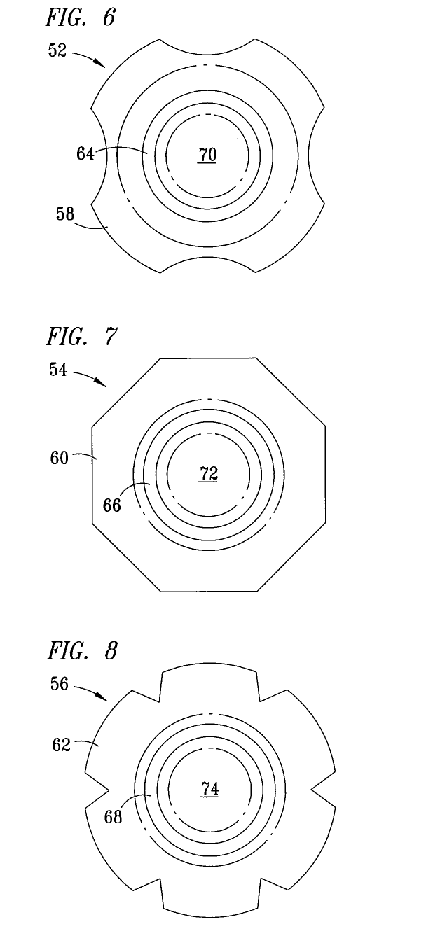

Furthermore, although the beverage container holders 30, 44 shown and described in relation to FIGS. 1-5 have bases with circular perimeters, it is seen in FIGS. 6-8 that the perimeter shapes of bases 58, 60, 62 of beverage container holders 52, 54, 56 respectively, can vary significantly within the parameters discussed above, while sidewalls 64, 66, 68 and interior voids 70, 72, 74 respectively are unchanged. In accordance with the invention, bases 32, 58, 60, 62 can themselves provide a visible element that is singularly identifiable by a user. Where the shape of the base is varied simultaneously with indicia such as football indicia 37 on a sidewall, it is possible, for example, to produce 16 (4×4) singularly identifiable beverage container holders by using only four different base configurations and four different (text, color, type of ball, etc.) decal indicia. It should also be appreciated upon reading this disclosure in relation to the accompanying drawings that each of bases 32, 58, 60, 62 has a principal transverse dimension meeting the criteria stated in paragraph [0014] even though bases 58, 60, 62 are not circular and therefore do not, strictly speaking, have a diameter (although it may be argued that each of bases 58, 60, 62 can be circumscribed by circles having equal or substantially equal diameters).

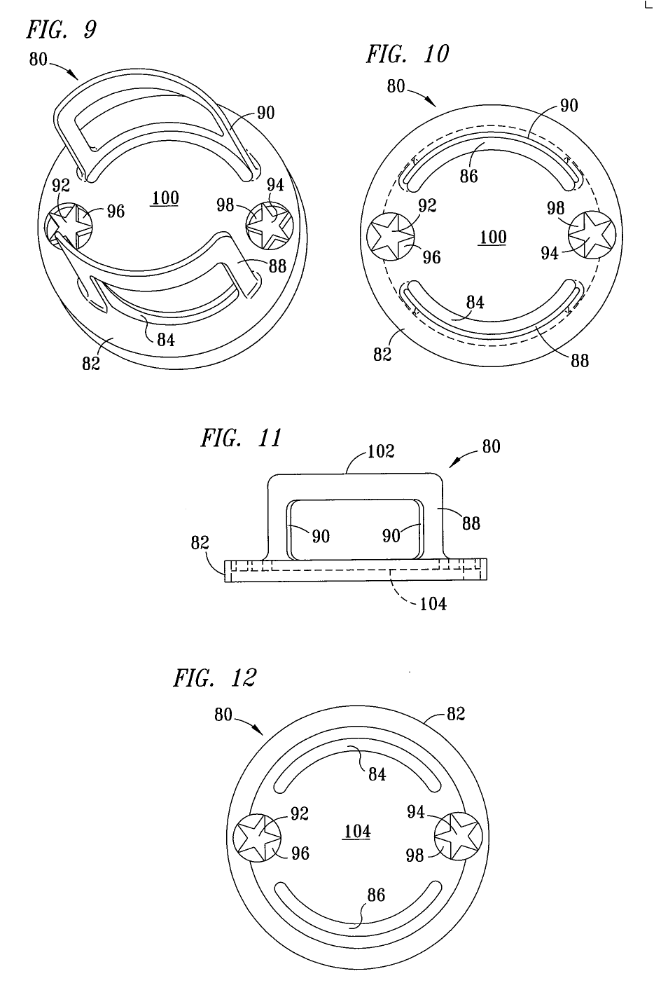

Referring to FIGS. 9-12, beverage container holder 80 comprises substantially circular base 82 having two opposed, spaced-apart, upwardly projecting arcuate structures 88, 90 that are desirably cooperatively configured to releasably engage and frictionally hold a beverage container such as a can or bottle between them. For illustrative purposes, each of structures 88, 90 is depicted as having spaced-apart vertical posts joined by an arcuate, horizontally disposed top rail. Slots 84, 86 in base 82 are desirably provided underneath each rail to facilitate molding. In this embodiment, the principal transverse dimension of base 82 is again greater than the height of upwardly projecting structures 88, 90 above base 82 and is also greater than the diameter of a circle circumscribing the outside of upwardly projecting structures 88, 90 and greater than the diameter of a usable beverage container plus twice the thickness of one of structures 88, 90.

Star-shaped indicia 92, 94 are provided inside voids 96, 98 for use as identifiers, and it will be recognized upon reading this disclosure that they can be painted or overlaid with differently colored decals to distinguish one from the other among a group, or some can be molded with other differently shaped indicia by changing inserts to the mold. With this embodiment, the height of top edge 102 (FIG. 11) above base 82 can be considered the height of the arcuate structures 88, 90 of beverage container holder 80. Also, in this embodiment, the interior bottom portion 104 of base 82 beneath the interior seating surface 100 for a beverage container is recessed slightly above the perimeter of base 82 to reduce material cost and provide an insulative air gap between the portion of base 82 underlying a beverage container (not shown) disposed inside holder 80 and an underlying support surface upon which base 82 rests when the beverage is not in the hands of the user.

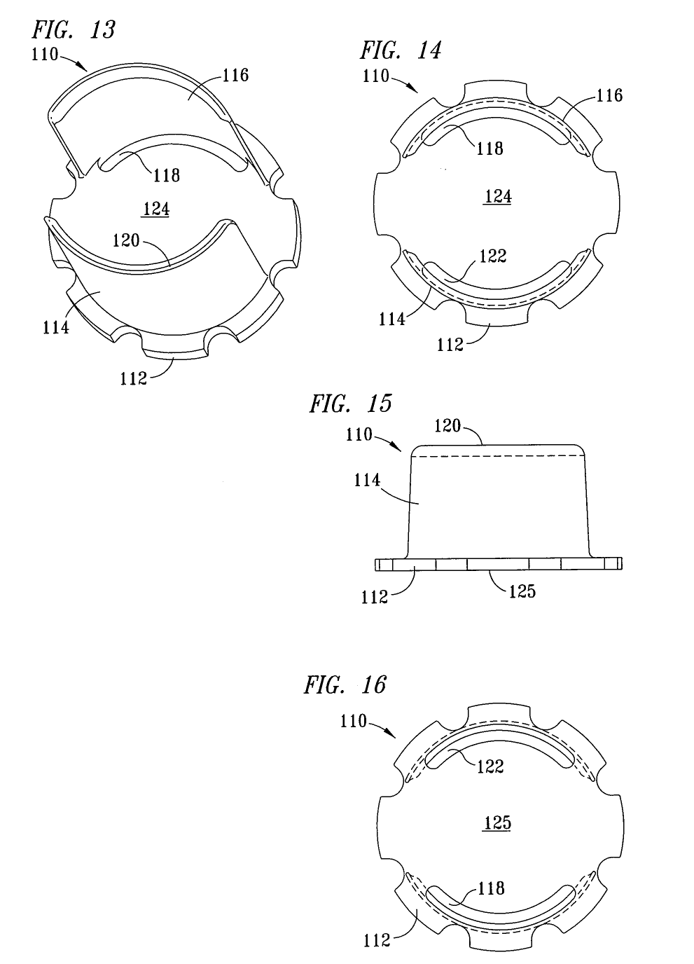

Referring to FIGS. 13-16, beverage container holder 110 comprises a scalloped, generally circular base 112 and opposed, upwardly projecting, continuous arcuate sidewall sections having inwardly projecting top edges 120 to assist in providing frictional engagement with the outside wall of a beverage container with which holder 110 is used. In this embodiment, the principal transverse dimension of base 112 is again greater than the height of sidewall sections 114, 116 above base 112 and is also greater than the diameter of a circle circumscribing the outside of arcuate sidewall sections 114, 116 and greater than the beverage container diameter plus twice the thickness of a sidewall section. Slots 118 and 122 are desirably provided in base 112 to facilitate molding of the inwardly projecting top edges 120 of arcuate sidewall sections 114, 116. In this embodiment, base 112 has a substantially constant thickness between upwardly facing surface 124 and downwardly facing bottom surface 125. In this embodiment, singularly identifiable indicia as described above can be placed upon or integrated into outwardly visible portions of sidewall sections 114, 116 to facilitate identification of the holder and distinguish it from others that may be in use at the same location or event. Similarly, if other beverage container holders are provided having other visually identifiable base configurations, the configuration of base 112 can itself be the element that is singularly identifiable by the user.

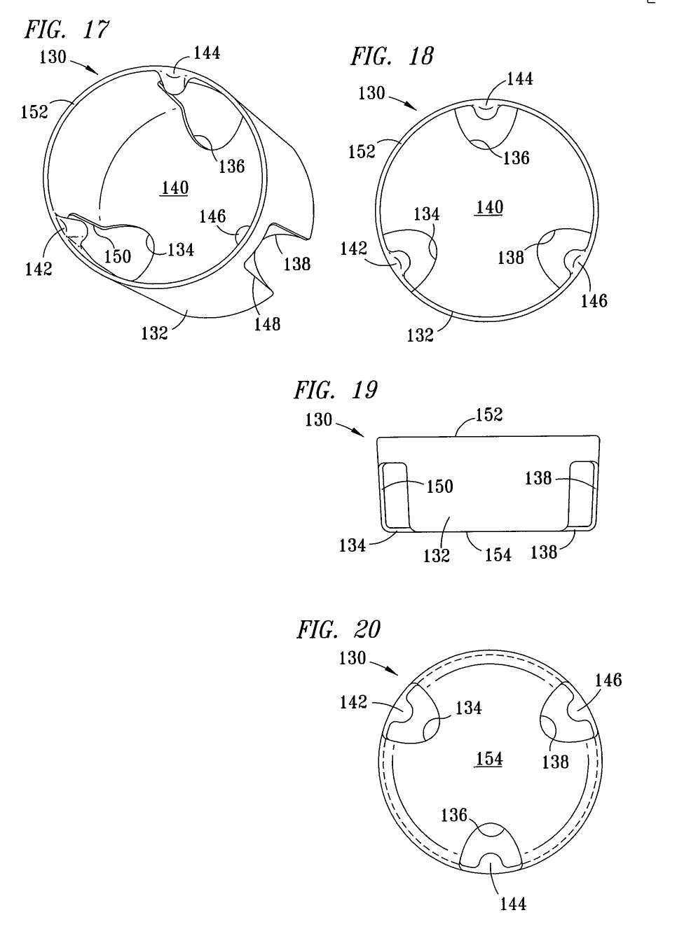

Referring to FIGS. 17-20, beverage container holder 130 comprises a base having a top surface 140, a bottom surface 154, and a plurality of circumferentially spaced, inwardly scalloped recesses 134, 136, 138 and a slightly tapered, substantially cylindrical sidewall 132 having a plurality of circumferentially spaced sidewall voids 150, 153, 148 communicating with recesses 134, 136, 138, respectively. The recesses in base 140 and sidewall 132 cooperate to facilitate molding of a plurality of inwardly facing projections 142, 144, 146 near the top edge 152 of sidewall 132, which projections desirably provide frictional engagement with a beverage container inserted into releasable engagement with beverage container holder 130. As discussed above in relation to the embodiment shown in FIG. 1, an indicia that is singularly identifiable can be applied to or incorporated into the outwardly facing surface of sidewall 132 to aid a user in distinguishing his beverage container from those being used by others.

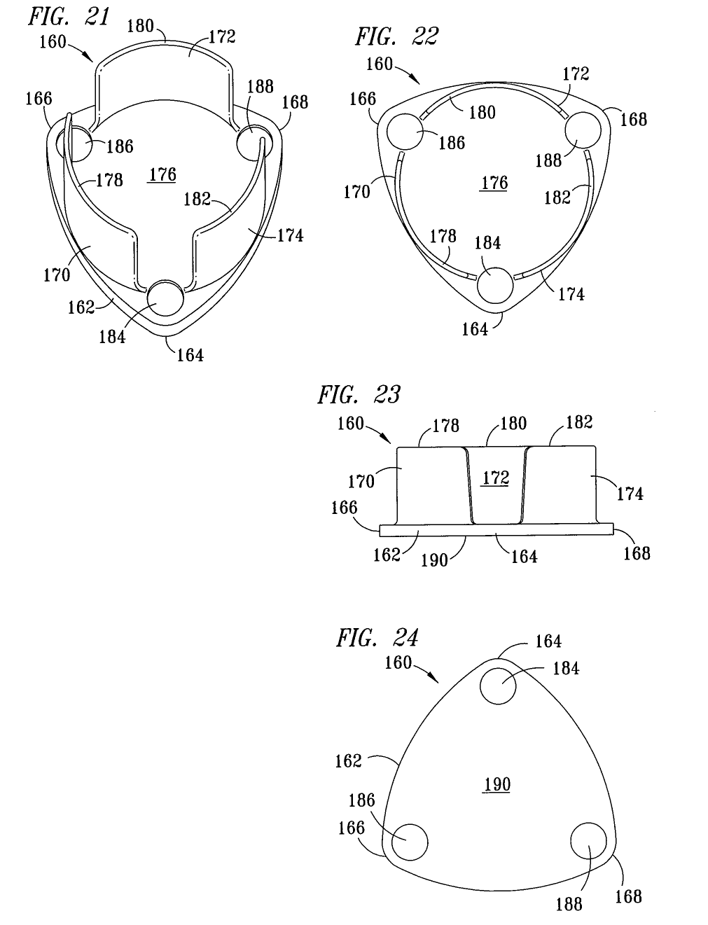

Referring to FIGS. 21-24, beverage container holder 160 comprises a three-sided base 162 having three radiused corners 164, 166, 168 formed at or near the intersection of three convex arcuate arcs, each of which constitutes a side of base 162. Three continuous arcuate sidewall sections 170, 172, 174 project upwardly from top surface 176 of base 162, with one such sidewall section being disposed between each radiused corner and the next sequential radiused corner disposed along the perimeter of base 162. According to one preferred embodiment of the invention, the arcuate midpoint of the outside surface of each of sidewall section 170, 172, 174 at the point of attachment to base 162 is tangent to the associated convex arcuate arc around the base. In this embodiment, the principal transverse dimension of base 162 is again greater than the height of arcuate sidewall sections 170, 172, 174 above upwardly facing surface 176 of base 162 and is also greater than the diameter of a circle circumscribing the outside of arcuate sidewall sections 170, 172, 174 and greater than the diameter of a beverage container with which holder 160 is used plus twice the thickness of an arcuate sidewall section 170, 172, 174. Outwardly projecting radiused corners 164, 166, 168 provide additional stability and tip resistance to beverage container holder 160. In the embodiment shown, base 162 has a substantially constant thickness between upwardly facing surface 176 and downwardly facing bottom surface 125. In this embodiment, apertures 184, 186 188 are optionally provided in base 176. Alternatively, singularly identifiable indicia as described above can be placed in the apertures or can be placed upon or integrated into outwardly visible portions of sidewall sections 170, 172, 174 to facilitate identification of the holder and distinguish it from others that may be in use at the same location or event. Similarly, if other beverage container holders are provided having other visually identifiable base configurations, the configuration of base 162 can itself be the element that is singularly identifiable by the user.

Although the use of a base having at least one element with a principal transverse dimension greater than diameter of a beverage container with which it is used plus twice the thickness of any upwardly projecting sidewall engaging the beverage container is one preferred configuration for improving the tip-over resistance of the subject beverage container holders, it will be appreciated by those of ordinary skill in the art upon reading the disclosure that tip-over resistance can also be provided in other ways. For example, one can weight the beverage container holders at or near the base by insert molding or otherwise attaching a weight to the base (such as inside recess 104 as shown and described in relation to FIG. 11) or by selecting a material and configuration for the subject beverage container holder that concentrates mass at or near the base and thereby lowers the center of gravity of the beverage container holder.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

1-5. (canceled)

6. A beverage container holder comprising a base and a plurality of flexible, arcuate wall sections, each arcuate wall section being separate from each other arcuate wall section and attached to the base independently of and in circumferentially spaced-apart relation to each other arcuate wall section, each arcuate wall section having a top edge with an inwardly projecting portion, which inwardly projecting portion cooperates with the inwardly projecting portion of each other arcuate wall section to receive a portion of a beverage container having a sidewall into a space disposed inwardly of the arcuate wall sections, and to releasably engage the beverage container sidewall, the beverage container holder including a visible indicia that is singularly identifiable by a user.

7. (canceled)

8-10. (canceled)

11. The beverage container holder of claim 6 wherein each arcuate side wall section is attached to the base along a circle circumscribing the sections and having a diameter, wherein the base further comprises a principal transverse dimension that is greater than the diameter of the circle.

12. The beverage container holder of claim 6 wherein the base further comprises at least one aperture extending through the base.

13. A plurality of beverage container holders wherein each such beverage container holder is made in accordance with claim 6 and wherein the visible indicia of each makes it singularly identifiable relative to the visible indicia of each other beverage container holder.

14. (canceled)

15. The beverage container holder of claim 6 wherein each arcuate wall section projects upwardly from the base.

16. (canceled)

17. The beverage container holder of claim 13 wherein the visible indicia is a color.

18. The beverage container holder of claim 6 wherein the base has a perimeter that is generally circular.

19. The beverage container holder of claim 18 wherein the base has a perimeter that is generally circular but comprises a plurality of inwardly scalloped recesses.
